(19) United States
(12) Patent Application Publication
(10) Pub. No.: US 2004/0052359 A1
(43) Pub. Date: Mar. 18, 2004

(54) Communication system

(76) Inventors: Sunao Takatori, Tokyo (JP); Hisanori Kiyomatsu, Matsudo-shi Chiba (JP)

Correspondence Address: Kanesaka & Takeuchi, Suite 2, 1423 Powhatan Street, Alexandria, VA, 22314, US

(21) Appl. No.: 10/466,752

(22) PCT Filed: May 30, 2001
(86) PCT No.: PCT/JP01/04517

(51) Int. Cl. H04M 1/64; H04M 1/00

(52) U.S. Cl. 379/387.01; 379/67.1

(57) ABSTRACT

It is an object of the present invention to provide a communication system, which can manage the contents of control transfer properly while adopting a control transfer method capable of making effective use of a telephone line. When use of a telephone line for a portable telephone 1 is transferred to slave terminals such as a portable telephone 10, a vending machine 11 with communication capability, a personal computer 12 with communication capability, and a car 13 with communication capability, the contents of transfer are stored in a predetermined memory of the portable telephone 1, while the contents of transfer to be transferred to each slave terminal are stored in a built-in memory of the slave terminal. On the other hand, a host computer 2 at an exchange is provided with a predetermined memory for cumulatively storing used transfer contents each time the slave terminal is connected using the transfer. The three memories are checked as appropriate to keep proper use of control transfer.

### TECHNICAL FIELD

The present invention relates to a communication system adopting a so-called control transfer method for transferring the telephone-line utility right of a master terminal or portable telephone to slave terminals or electrical appliances with communication capability to ensure effective use of the telephone line. In particular, it relates to a communication system for enabling proper use of the transfer of control by managing the contents of the control transfer that has already been transferred, that is, the control transfer history, and the already-used control transfer in a control transfer history.

### BACKGROUND ART

As communication apparatuses such as portable telephones have developed and their penetration has increased, techniques for adding a communication function utilizing a telephone line to various apparatuses (TV sets, stereo sets, home electric appliances such as refrigerators and air conditioners, motor vehicles, vending machines, personal computers, and so on) have been proposed. These techniques are used to send a control signal from a portable telephone or the like through the telephone line for remote operation of these apparatuses, or to receive various data stored in these apparatuses or data indicative of current states of these apparatuses through the telephone line. Such techniques are expected to rapidly proceed toward commercialization in the near future.

If the above-mentioned techniques have rapidly proceeded toward commercialization, each of the above-mentioned various apparatuses will probably have a respective telephone number even in an ordinary household to realize the above-mentioned techniques through each telephone line related to the telephone number. In this case, however, many telephone numbers are owned by the ordinary household, which makes management of the telephone numbers complicated. Further, when subscriber's basic charges for and frequency of use of the telephone lines are considered, the cost mounts wastefully.

In view of the above-mentioned circumstances, we have already proposed a communication system adopting a telephone-line transfer method (see Japanese patent application Nos. 2000-038404 and 2000-122791).

In the communication system, a slave terminal or each of various apparatuses with communication capability is given a slave terminal ID. The slave terminal ID is composed of a telephone number of a master terminal or portable telephone assigned the telephone number thereto and other parts, and is recognizable by a telephone network including a host computer of an exchange. The slave terminal is connected to the host computer over the telephone line related to the telephone number of the master terminal using the slave terminal ID in response to input of a predetermined key. Then, the slave terminal receives permission of use of the telephone line and access to other services, that is, the transfer of the right to control the telephone line, within a predetermined range with charges billed to the master terminal.

Thus, if the communication system is provided with one master terminal such as a portable telephone given a telephone number, the right to control a telephone line can be transferred to many slave terminals to share one telephone line between the master terminal and each of the many slave terminals. This makes possible effective use of the telephone line, avoiding the above-mentioned complication and cost problem.

The communication system adopting the above-mentioned telephone-line transfer method can be free from the complication and cost problem caused by possession of many telephone numbers, but the management of wide-ranging control contents to be transferred to each slave terminal becomes hard. Inadequate management may result in wrong use of the telephone line.

The present invention has been made in view of the above-mentioned circumstances, and it is an object thereof to provide a communication system, which can manage properly the contents of control transfer while adopting a control transfer method capable of making effective use of a telephone line.

### DISCLOSURE OF THE INVENTION

In the first invention, there is provided a communication system adopting a control transfer method, the communication system including

a host computer provided at an exchange of a common carrier,

a master terminal given a predetermined master terminal ID and connected to the host computer over a telephone line related to the master terminal ID in response to input of a predetermined key, and

a slave terminal which is specified by a slave terminal ID composed of the master terminal ID part and other parts and recognized by a telephone network of the common carrier including the host computer and which is equipped with a communication terminal unit connected to the host computer over the telephone line related to the master terminal ID in response to input of a predetermined key and given control transfer within a predetermined range with charges billed to the master terminal.

In the communication system, the master terminal comprises

control transfer storing means for storing the contents of the control transfer in a control transfer history memory in a predetermined storage unit each time control is transferred to the slave terminal, and

information means which, when a deviation informing signal, as mentioned below, is transmitted from the host computer, informs about the contents of deviation based on the deviation informing signal,

the host computer comprises

already-used transfer storing means for cumulatively storing the contents of control transfer used in an already-used control transfer memory in a predetermined storage unit each time the slave terminal is connected to the host computer to use control transfer, and

deviation signal transmitting means which establishes the telephone line with the master terminal every time the slave terminal is connected to the host computer to use the control transfer or periodically, then checks the contents of the control transfer stored in the control transfer history memory in the master terminal against the contents of the already-used control transfer stored in the already-used control transfer memory in the host computer and, if the latter deviates from the former, transmits to the master terminal the deviation informing signal indicative of the contents of deviation.

In the second invention, the communication system according to the first aspect of the present invention is subjected to addition of some structural elements.

In other words, the master terminal further comprises

master-side short-distance transmission means for transmitting the contents of the control transfer to the slave terminal each time control is transferred to the slave terminal, and

the communication terminal unit of the slave terminal comprises

reception and storage means for receiving the contents of the control transfer transmitted from the master terminal to store the same in a control transfer history memory in a predetermined storage unit, and

transferred content transmitting means which, when the telephone line is established between the slave terminal and the host computer to allow the slave terminal to use the control transfer, transmits the contents of the control transfer stored in the control transfer history memory to the host computer prior to use of the control transfer, and

the host computer further comprises

use of control transfer halting means for halting the use of the control transfer of the slave terminal at the time when, as a result of checking the contents of the control transfer transmitted from the slave terminal through the transferred contents transmitting means against the contents of the already-used control transfer stored in the already-used control transfer memory in the host computer, the latter deviates from the former.

In the third invention, there is provided a communication system adopting a control transfer method, the communication system including

a host computer provided at an exchange of a common carrier,

a master terminal given a predetermined master terminal ID and connected to the host computer over a telephone line related to the master terminal ID in response to input of a predetermined key, and

a slave terminal which is specified by a slave terminal ID composed of the master terminal ID part and other parts and recognized by a telephone network of the common carrier including the host computer and which is equipped a communication terminal unit connected to the host computer over the telephone line related to the master terminal ID in response to input of a predetermined key and permitted use of the telephone line and access to other services from the master terminal within a predetermined range with charges billed to the master terminal, that is to say, given the control transfer.

In the communication system, the master terminal comprises

master-side short-distance transmission means for transmitting the contents of the control transfer to the slave terminal each time control is transferred to the slave terminal, and

the communication terminal unit of the slave terminal comprises

reception and storage means for receiving the contents of the control transfer transmitted from the master terminal to store the same in a control transfer history memory in a predetermined storage unit, and

transferred content transmitting means which, when the telephone line is established between the slave terminal and the host computer to allow the slave terminal to use the control transfer, transmits the contents of the control transfer stored in the control transfer history memory to the host computer prior to use of the control transfer, and

the host computer comprises

already-used transfer storing means for cumulatively storing the contents of used control transfer in an already-used control transfer memory in a predetermined storage unit each time the slave terminal is connected to the host computer to use control transfer, and

use of control transfer halting means for halting the use of the control transfer of the slave terminal at the time when, as a result of checking the contents of the control transfer transmitted from the slave terminal through the transferred contents transmitting means against the contents of the already-used control transfer stored in the already-used control transfer memory, the latter deviates from the former.

In the fourth invention, the communication system according to any one of the first to third aspects of the present invention is such that at least some of the following six items, the master terminal ID for the master terminal from which control transfer has been carried out, the slave terminal ID for the slave terminal which has received the control transfer, the date and time the control transfer has been used, the purpose of utilization, the amount of charge for the utilization, and the cumulative amount of charge for the use of the control transfer, are stored as the contents of the already-used control transfer in the already-used control transfer memory in the host computer.

### BRIEF DESCRIPTION OF THE DRAWINGS

FIG. 1 is a diagram showing the general structure of one preferred embodiment of the present invention.

FIG. 2 is a diagram showing a configuration of a portable telephone 1 shown in FIG. 1.

FIG. 3 is a diagram showing a configuration of a slave terminal such as a portable telephone 10 shown in FIG. 1.

FIG. 4 is a general flowchart showing an outline of the operation of the master terminal.

FIG. 5 is a general flowchart showing an outline of the operation of the slave terminal.

FIG. 6 is a general flowchart showing an outline of the operation of a host computer 2 at an exchange.

FIG. 7 is a diagram showing a storage state of a control transfer history memory of the master terminal.

FIG. 8 is a diagram showing a storage state of a control transfer history memory of the slave terminal and that of an already-used control transfer memory of the host computer 2 at the exchange.

### BEST MODE FOR CARRYING OUT THE INVENTION

The present invention will be described in detail according to the attached drawings.

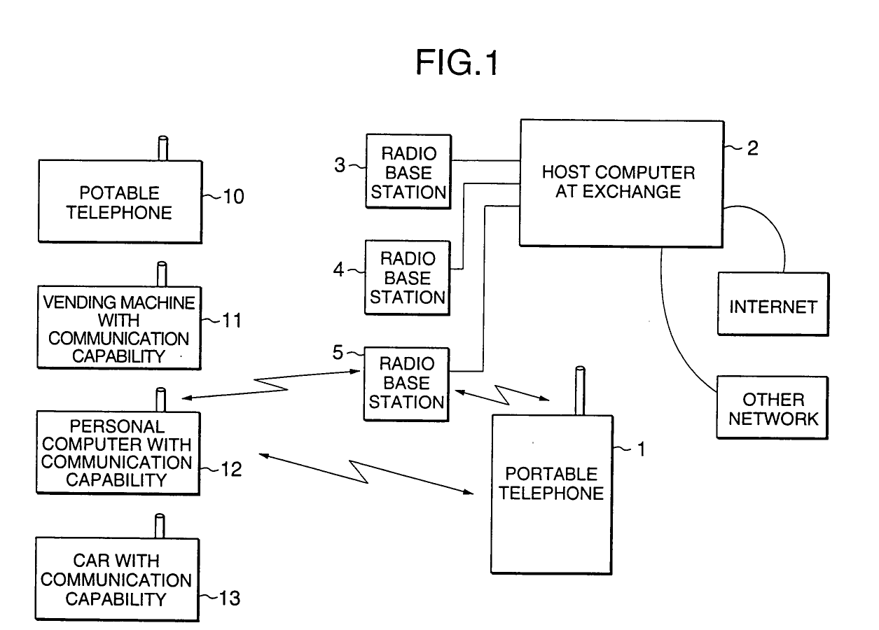

FIG. 1 is a diagram showing a schematic configuration of the embodiment. In a communication system according to the embodiment, a portable telephone 1 is the master terminal having an independent master terminal ID. A host computer 2 at an exchange and radio base stations 3, 4, 5 belong to a network of a common carrier with which an owner of the portable telephone 1 has made a subscriber contract. In other words, if the portable telephone 1 is a calling side terminal in such a normal case that control of the telephone line is not transferred, a calling signal or the like from the portable telephone 1 reaches the host computer 2 at the exchange via any one of the radio base stations 3, 4, 5. Further, the calling side terminal may selectively be connected to the Internet or other networks by the host computer 2 at the exchange. In the embodiment, there are provided four apparatuses or slave terminals, each of which has communication capability but is not given an independent telephone number, that is, a portable telephone 10, a vending machine 11 with communication capability, a personal computer 12 with communication capability, and a car 13 with communication capability.

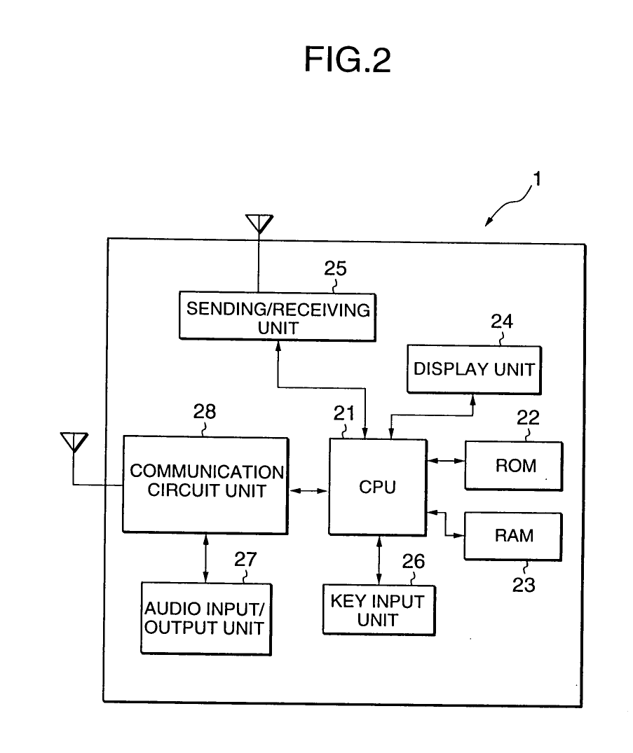

FIG. 2 shows a circuit configuration of the portable telephone 1. Like an ordinary portable telephone, the portable telephone 1 is provided with a CPU 21, a ROM 22, a RAM 23, a display unit 24, a sending/receiving unit 25 having an antenna for exchanging signals with the host computer 2 at the exchange through a radio base station 3 or the like, an audio input/output unit 27 with a microphone and a speaker, and a key input unit 26 with a dial key and the like. However, the portable telephone 1 is different from the normal one in that it is further provided with a communication circuit unit 28 that is used for the sending/receiving between this portable telephone 1 and slave terminal and that is also a part of structural elements of the master-side short-distance transmission means.

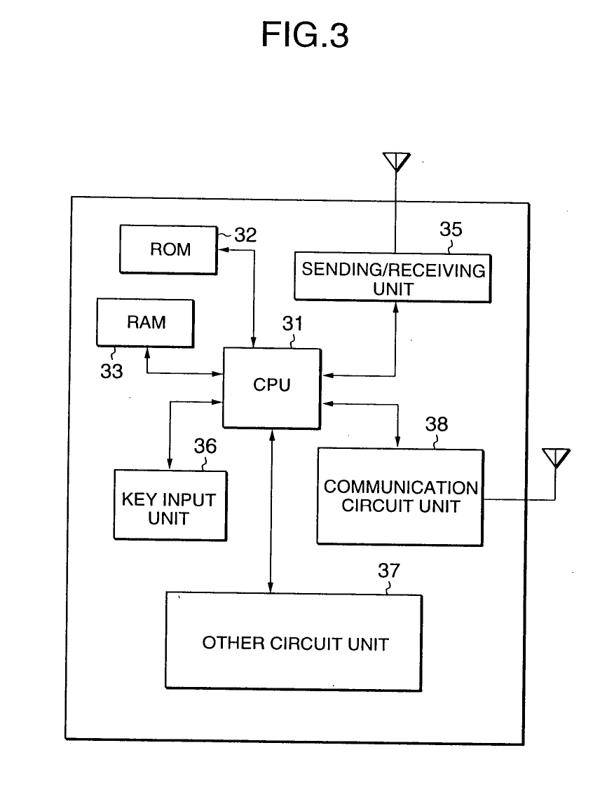

FIG. 3 shows a circuit configuration of the slave terminal, that is the portable telephone 10, the vending machine 11 with communication capability, the personal computer 12 with communication capability, or the like. The slave terminal is provided with a sending/receiving unit 35 that constitutes main part of the communication terminal unit, a communication circuit unit 38 for use in exchanging signals with the master terminal and also as a part of structural elements of the reception and storage means, a CPU 31, a ROM 32, a RAM 33, a key input unit 36 and other circuit unit 37 (including a circuit unit for carrying out the operation or processing unique to the slave terminal, which corresponds to, in the case of the personal computer 12 with communication capability, a circuit unit indispensable to a personal computer such as a display unit or a hard disk drive).

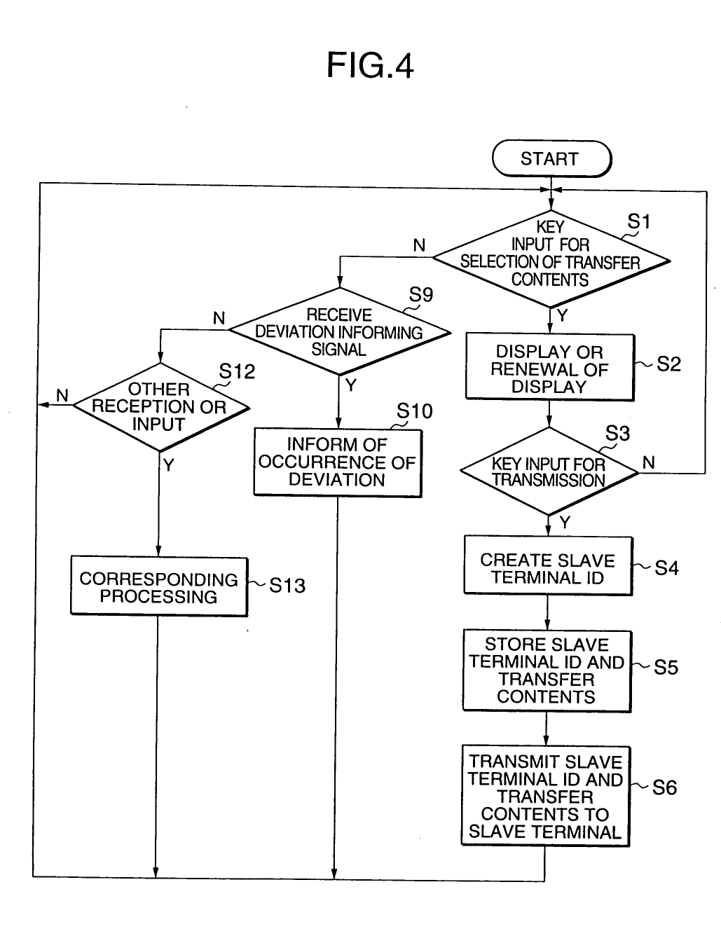

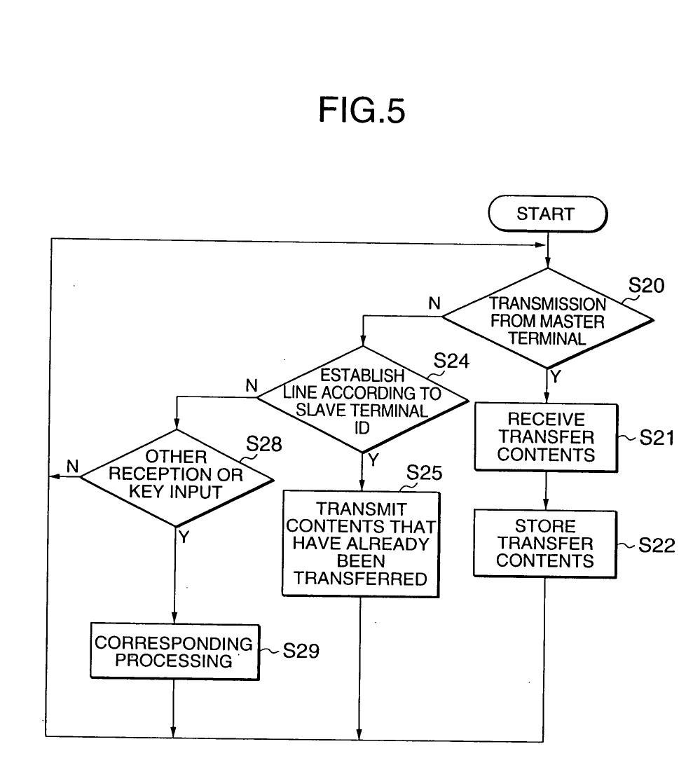

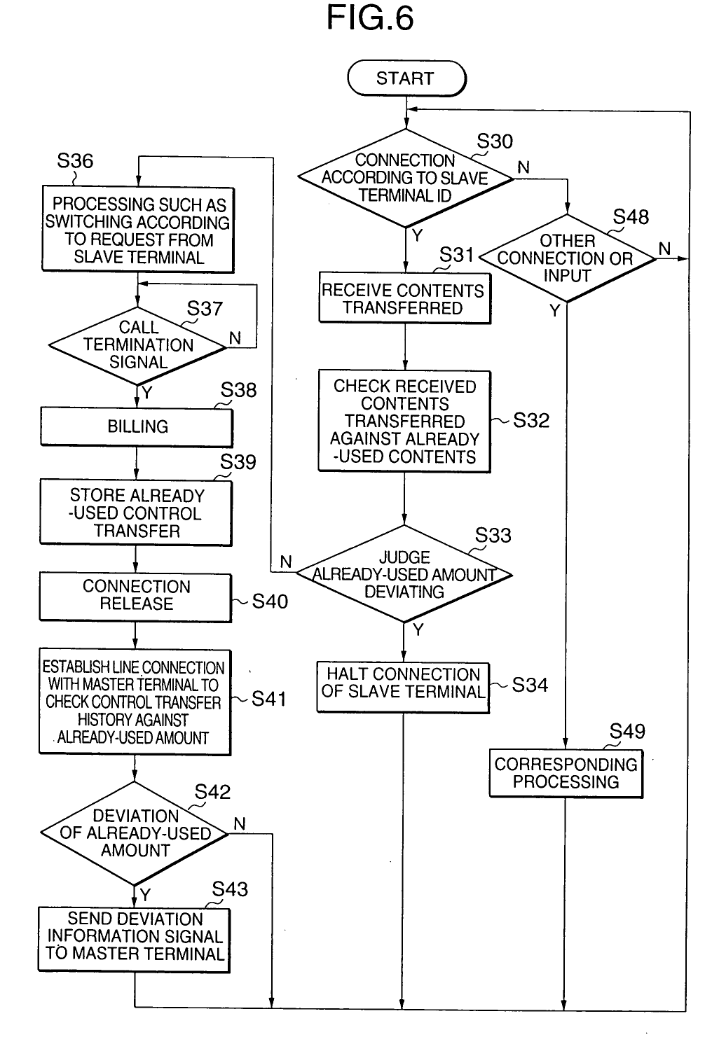

Next, the operation of the above-mentioned embodiment configured such above, especially the management operation of control transfer is mainly described with reference to the flowchart of FIG. 4, which shows an outline of the operation of the master terminal 1, the flowchart of FIG. 5, which shows an outline of the operation of the slave terminal, the flowchart of FIG. 6, which shows an outline of the operation of the host computer 2 at the exchange, and so on.

At first, upon deciding the contents of control to be transferred, the owner of the portable telephone 1 operates a key on the key input unit 26 to select the contents of control transfer while displaying the same on the display unit 24. At this time, the CPU 21 of the portable telephone 1 repeats a sequence of operations of steps S1, S2, S3 and S1 to detect input of key operations so as to display the contents of the control transfer on the display unit 24 or renew the display screen. At the time target contents of control transfer are displayed and selected on the display unit 24, the owner places the portable telephone 1 near the slave terminal to which control is to be transferred, for example, the personal computer 12 with communication capability to operate a predetermined key. At this time, the key operation is detected in step S3, and the processing procedure advances to step S4 and steps following step S4. In other words, a branch number is appended to a master terminal ID of the portable telephone 1 to create a slave terminal ID. The slave terminal ID and the contents of the control transfer selected in the above selection process are stored in the control transfer history memory in the RAM 23, and then sent to the slave terminal such as the personal computer 12 with communication capability through the transmission circuit unit 28 (steps S4, S5 and S6).

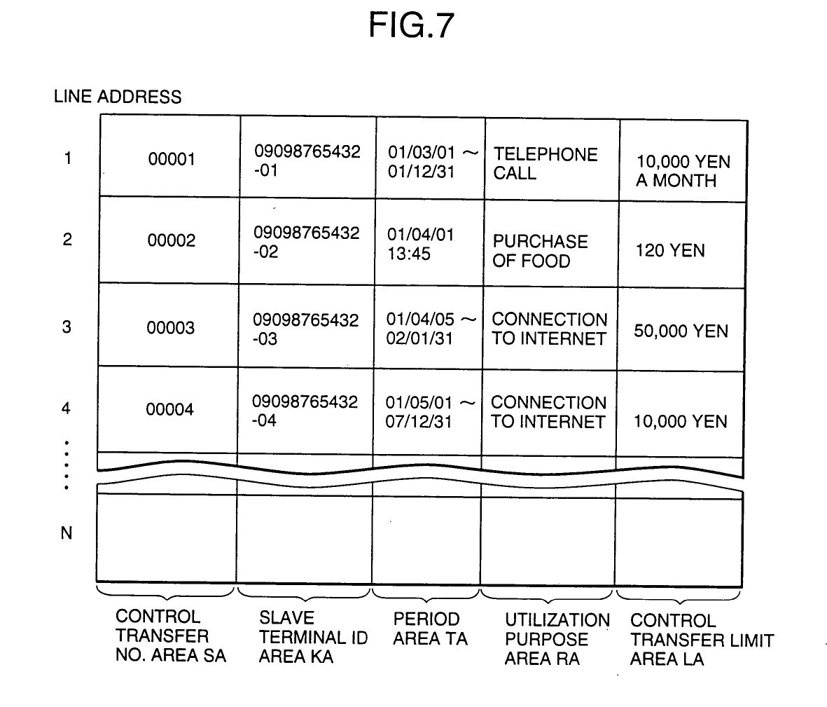

The sequence of the above-mentioned operations is so repeated that the portable telephone 1 transfers control one by one to each of the slave terminals. As a result, a control transfer history, for example, as shown in FIG. 7, is stored in the control transfer history memory of the portable telephone 1. In other words, the contents of control transfer are stored for each transfer on a storage area in each line. For example, the contents of control transfer No. 00001 are stored in the line with line address (relative line address) 1. That is to say, in this line, the following four items are stored. The first item is that the slave terminal ID given to the slave terminal (portable telephone 10) upon transferring the control is 0909876543201 (where a branch number of 01 is appended to the master terminal ID or the telephone number of the master terminal). The second item is that the transfer period is from Mar. 1, 2001 to Dec. 31, 2001. The third item is that the purpose (mode) of utilization is to provide telephone calls with other telephones. The fourth item is that the limit of utilization or control transfer permitted to the portable telephone 10 is 10,000 yen a month. Further, the contents of control transfer No. 00002 are stored in the line with line address 2. That is to say, in this line, the following four items are stored. The first item is that a slave terminal ID given to the slave terminal (vending machine 11 with communication capability) upon transferring the control is 09098765432-02 (a branch number of 02 is appended to the master terminal ID or the telephone number). The second item is that the transfer period is a predetermined time (e.g., one minute) from 1:45 p.m., Apr. 1, 2001. The third item is that the purpose (mode) of utilization is to buy food at the vending machine 11 with communication capability. The fourth item is that the limit of utilization or control transfer is 120 yen. Similarly, in the line with line addresses 3 and 4, the contents of control transfer to the personal computer 12 with communication capability and the car 13 with the communication capability are stored respectively.

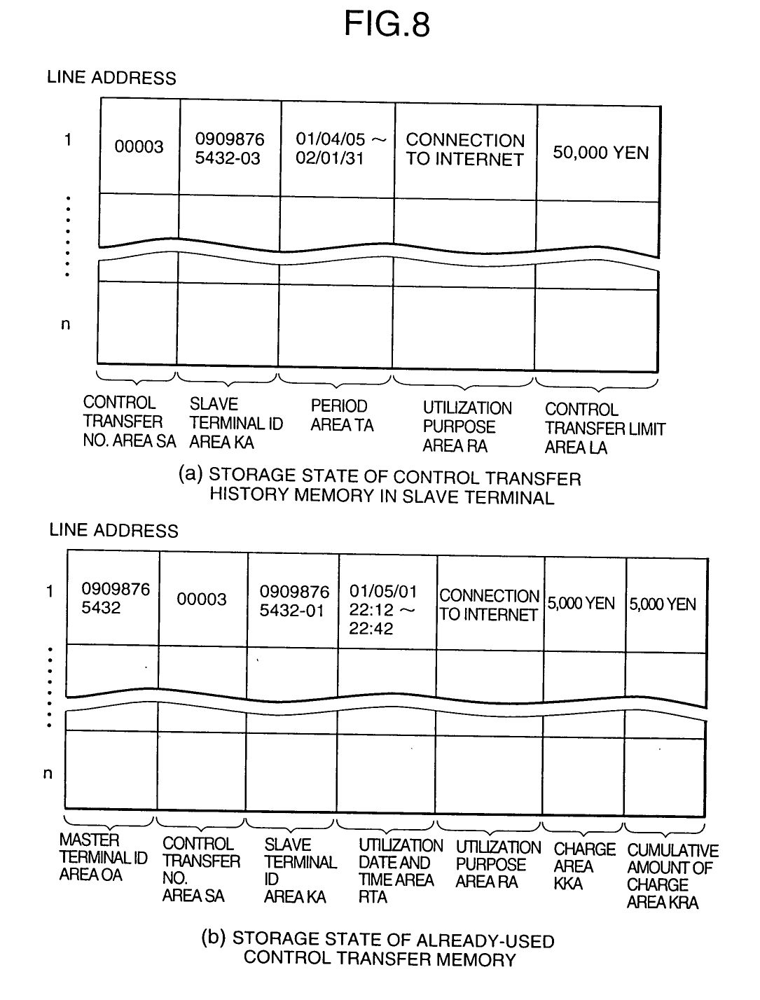

Next, description will be made on the operation of the slave terminal (to which the control is transferred) when the master terminal or the portable telephone 1 transfers control to the slave terminal in the above-mentioned manner. On the transmission from the portable telephone 1 (see step S6 in FIG. 4), the slave terminal detects the transmission in step S20 of FIG. 5. In step S21, the slave terminal receives the contents of control transfer using the communication circuit unit 38. Then, the processing procedure advances to step S22 in which the contents of the control transfer received are stored in the control transfer history memory in the RAM 33. For example, when the portable telephone 1 transfers the control which is stored in the line with line address 3 of FIG. 7 to the personal computer 12 with communication capability, the contents of the control transfer identical to those stored in the line with line address 3 of FIG. 7 are stored in such a manner as shown in FIG. 8 in the control transfer history memory of the personal computer 12 with communication capability at which the control transfer has been received.

Upon using the control transfer after the slave terminal has received the control transfer in the above-mentioned manner, the user will operate a key, using the slave terminal ID, in order to establish a connection over the telephone line with the host computer 2 at the exchange. At this time, the key input operation is detected in step S24, and in the next step S25 the contents of the control transfer which have been stored in the control transfer history memory of the RAM 33 and which are used this time are sent to the host computer 2 at the exchange.

Upon receipt of the line connection produced by the slave terminal through the use of the slave terminal ID, the host computer 2 at the exchange detects the line connection in step S30 of FIG. 6. Then the processing procedure advances to step S31 in which the host computer 2 receives the contents of the control transfer sent from the slave terminal. After that, in step S32 the host computer 2 checks the received contents of the control transfer against the already-used control transfer related to the control transfer concerned and stored in the already-used control transfer memory thereof. If the checking results show that the already-used control transfer deviates from the contents of the control transfer received (for example, when the cumulative amount of this-month's charge has already reached a monthly control transfer limit of 50,000 yen), the processing procedures advances to step S34 via step S33. In step S34, the connection with the slave terminal is halted, that is, the telephone line is released.

On the other hand, if it is determined that there is no deviation as a result of checking, the processing procedure advances to step S36 via step S33. In step S36, required processing such as telephone line switching is executed in response to request signals sent from the slave terminal from then on. For example, a line connection with a telephone with a telephone number delivered as that of a called side, a line connection with an access point of the telephone number delivered, or transmission of a certain control signal to the slave terminal (in case the slave terminal is the vending machine 11 with communication capability, this transmission corresponds to the transmission of a control signal to instruct the slave terminal to dispense required food) is executed.

The completion of the processing such as telephone line switching is detected in step S37, and the processing procedure advances to step S38. In step S38, the portable telephone 1 or the master terminal is billed for the line connection or the service the slave terminal has received through the line connection (such as to download pay information over the Internet or dispense food from the above-mentioned slave terminal).

After the execution of the processing in the above-mentioned step S38, in step39, the control transfer used by the line connection in other words the already-used control transfer is obtained and stored in the already-used control transfer memory. Suppose that the line connection uses the control transfer of the control transfer No. 00003 shown in FIG. 8(a). Suppose further that the billed amount this time and the cumulative amount of charge are both 5,000 yen. The storage state of the already-used control transfer memory in this case is shown in FIG. 8(b).

Next, the above line connection is released in step S40, and a line is established (connected) in step S41 with the portable telephone 1 as the master terminal for a very short period of time. During that period, the contents of the control transfer used this time (of the control transfer No. 00003 in the above-mentioned example) stored in the control transfer history memory on the portable telephone 1 are captured. Then the contents of the control transfer captured are checked against the already-used control transfer stored in the already-stored control transfer memory. If the already-used control transfer deviates from the control transfer (for example, if the already-used control transfer exceed the limit of control transfer), the processing procedure advances to step S43 via step S42. In step S43, a deviation informing signal indicative of the deviation is sent to the portable telephone 1 from the host computer 2. If it is determined in step S42 that there is no deviation or after completion of the operation of the above-mentioned step S43, the sequence of operations executed by the host computer 2 at the exchange is ended.

Upon receipt of the deviation informing signal, the portable telephone 1 detects the same in step S9 of FIG. 4 to inform the owner of the occurrence of the deviation in the control transfer (of the control transfer No. 00003 in the above-mentioned example) (for example, in such a manner as to display on the display unit 24).

The scope of the present invention is not limited to the above-mentioned embodiment, and various modifications and applications are possible. For example, the operations of the host computer 2 at exchange after step S41 in FIG. 6 according to the above-mentioned embodiment may be executed periodically, such as once a day or every other day, instead of executing each time control transfer is used. Further, the operations following step S41 is not limited to the transmission of the deviation signal in step 43. For example, such a flag as to indicate that it is prohibited to establish the telephone line using the control transfer (of the control transfer No. 00003 in the above-mentioned example) may be set in a predetermined register. Based on the flag, further connection of the telephone line between the host computer and the slave terminal using the control transfer may be prohibited or may be allowed only if the host computer receives an acknowledgment signal from the master terminal immediately after the transmission of a signal which indicates the effect to the master terminal. It should be noted that all the measures after the occurrence of the deviation may be taken only when the degree of deviation becomes too great.

### INDUSTRIAL APPLICABILITY

As described above, the communication system according to the present invention is of great value in that it can manage the contents of control transfer properly while adopting a control transfer method capable of making effective use of a telephone line.

1. A communication system adopting a control transfer method, the system including
a host computer provided at an exchange of a common carrier,
a telephone (hereinbelow, called a master terminal) given a predetermined telephone number (hereinbelow, called a master terminal ID) and connected to the host computer over a telephone line related to the master terminal ID in response to input of a predetermined key, and
apparatus with communication capability (hereinbelow, called a slave terminal) which is specified by a slave terminal identification number (hereinbelow, called a slave terminal ID) composed of said master terminal ID part and other parts and recognized by a telephone network of the common carrier including said host computer and which is equipped with a communication terminal unit connected to said host computer over the telephone line related to said master terminal ID in response to input of a predetermined key and given permission of use of the telephone line and access to other services from said master terminal within a predetermined range with charges billed to said master terminal (hereinbelow, the above mentioned permission is called control transfer), wherein
said master terminal comprises
control-transfer storing means for storing the contents of the control transfer in a control transfer history memory in a predetermined storage unit each time control is transferred to said slave terminal, and
information means which, when a deviation informing signal mentioned below is transmitted from said host computer, informs about the contents of deviation based on the deviation informing signal,
said host computer comprises
already-used transfer storing means for cumulatively storing the contents of control transfer used in an already-used control transfer memory in a predetermined storage unit each time said slave terminal is connected to said host computer to use control transfer, and
deviation signal transmitting means which establishes the telephone line with said master terminal every time said slave terminal is connected to said host computer to use the control transfer or periodically, then checks the contents of the control transfer stored in the control transfer history memory in said master terminal against the contents of the already-used control transfer stored in the already-used control transfer memory in said host computer and, if the latter deviates from the former, transmits to said master terminal the deviation informing signal indicative of the contents of deviation.

2. The communication system according to claim 1, wherein said master terminal further comprises
master-side short-distance transmission means for transmitting the contents of the control transfer to said slave terminal each time control is transferred to said slave terminal, and
the communication terminal unit of said slave terminal comprises
reception and storage means for receiving the contents of the control transfer transmitted from said master terminal to store the same in a control transfer history memory in a predetermined storage unit, and
transferred content transmitting means which, when the telephone line is established between said slave terminal and said host computer to allow said slave terminal to use the control transfer, transmits the contents of the control transfer stored in the control transfer history memory to said host computer prior to use of the control transfer, and
said host computer further comprises
use of control transfer halting means for halting the use of the control transfer of said slave terminal at the time when, as a result of checking the contents of the control transfer transmitted from said slave terminal through said transferred contents transmitting means against the contents of the already-used control transfer stored in the already-used control transfer memory in said host computer, the latter deviates from the former.

3. A communication system adopting a control transfer method, the communication system including
a host computer provided at an exchange of a common carrier,
a master terminal given a predetermined master terminal ID and connected to the host computer over a telephone line related to the master terminal ID in response to input of a predetermined key, and
a slave terminal which is specified by a slave terminal ID composed of the master terminal ID part and other parts and recognized by a telephone network of the common carrier including said host computer and which is equipped a communication terminal unit connected to said host computer over the telephone line related to the master terminal ID in response to input of a predetermined key and permitted use of the telephone line and access to other services from said master terminal within a predetermined range with charges billed to said master terminal, that is to say, given the control transfer, wherein
said master terminal comprises
master-side short-distance transmission means for transmitting the contents of control transfer to said slave terminal each time control is transferred to said slave terminal, and
the communication terminal unit of said slave terminal comprises
reception and storage means for receiving the contents of the control transfer transmitted from said master terminal to store the same in a control transfer history memory in a predetermined storage unit, and
transferred content transmitting means which, when the telephone line is established between said slave terminal and said host computer to allow said slave terminal to use the control transfer, transmits the contents of the control transfer stored in the control transfer history memory to said host computer prior to use of the control transfer, and
said host computer comprises
already-used transfer storing means for cumulatively storing the used contents of control transfer in an already*used control transfer memory in a predetermined storage unit each time said slave terminal is connected to said host computer to use control transfer, and
use of control transfer halting means for halting the use of the control transfer of said slave terminal at the time when, as a result of checking the contents of the control transfer transmitted from said slave terminal through said transferred contents transmitting means against the contents of the already-used control transfer stored in said already-used control transfer memory, the latter deviates from the former.

4. The communication system according to any one of claims 1 to 3, wherein at least some of the following six items, the master terminal ID for said master terminal from which control transfer has been carried out, the slave terminal ID for said slave terminal which has received the control transfer, the date and time the control transfer has been used, the purpose of utilization, the amount of charge for the utilization, and the cumulative amount of charge for the use of the control transfer, are stored as the contents of the already-used control transfer in the already-used control transfer memory in said host computer.
